(19) United States
(12) Patent Application Publication
(10) Pub. No.: US 2026/0079036 A1
(43) Pub. Date: Mar. 19, 2026

(54) FLUID LEVEL SENSOR WITH A CAPACITIVE TOUCH FUNCTION FIELD CONFIGURATOR

(71) Applicant: Setra Systems LLC, Boxborough, MA (US)

(72) Inventor: Nathan H. KULAK, Collinsville, CT (US)

(21) Appl. No.: 19/312,217

(22) Filed: Aug. 27, 2025

Related U.S. Application Data
(60) Provisional application No. 63/694,741, filed on Sep. 13, 2024.

(51) Int. Cl. G01F 23/263; G06F 3/044

(52) U.S. Cl. CPC G01F 23/263; G06F 3/044

(57) ABSTRACT

Systems, apparatuses, and methods provide for a fluid level sensor including a fluid level sensor plate, a touch sensor plate, and a control unit. The fluid level sensor plate comprises a plate of conductive material. The touch sensor plate comprises a plate of conductive material. The control unit is coupled to the fluid level sensor plate and the touch sensor plate. The control unit is configured to determine fluid presence based on fluid level data from the fluid level sensor plate and determine touch input based on touch data from the touch sensor plate.

### FIELD

The instant disclosure relates generally to systems, apparatuses, and methods for fluid level sensing. In particular, embodiments of the instant disclosure relate to systems, apparatuses, and methods for a fluid level sensor with a capacitive touch function field configurator.

### BACKGROUND

Capacitive based sensing is a common technical modality for the detection of liquids in a container (e.g., tanks, pipes, or other vessels). Capacitive based sensors typically monitor an electric field generated by a fill level sensor and corresponding reference electrode. The fill level of fluid in a container affects this electric field due to a difference between a dielectric constant of the fluid in the container and a dielectric constant of the gas in the container (i.e., in the space above the fluid and still within the container). As the fluid level changes, the shifting ratios of the dielectric constant of the fluid and the dielectric constant of the gas likewise changes the capacitance value established by the fill level sensor. These capacitive based sensors come in both continuous and single point varieties.

The need to positively identify the presence of liquid in a vessel is critical to many process control applications including, but not limited to: medical devices, food and beverage processing, pharmaceutical production, water treatment equipment, semiconductor processing equipment, 3D printing, agricultural applications, and/or the like.

In cases where the sensor is considered non-contact (that is mounted external to a vessel wall), it is often desirable to field configure the device to accommodate changing physical conditions. A common means of doing this outside of a dedicated communication protocol is to have a “teach function” wire included in the sensor's wiring bundle. However, implementing such a teach function requires additional cost, requires additional power consumption, and requires additional design complexity.

### SUMMARY

Advantageously, some implementations discussed herein provide a convenient touch feature on the fluid level sensor that can be utilized to enable a field configuration mode without requiring a “teach function wire” or external power to be supplied to said wire. In some implementations, the touch feature is a capacitive touch sensor plate, although it may also be a push button, inserting and removing a conductive rod into a blind pocket, or any other form.

As will be described in greater detail below, in some implementations discussed herein, systems, apparatuses, and methods provide for a fluid level sensor including a fluid level sensor plate, a touch sensor plate, and a control unit. The fluid level sensor plate comprises a plate of conductive material. The touch sensor plate comprises a plate of conductive material. The control unit is coupled to the fluid level sensor plate and the touch sensor plate. The control unit is configured to determine fluid presence based on fluid level data from the fluid level sensor plate and determine touch input based on touch data from the touch sensor plate.

In one example, a method includes positioning a fluid level sensor on the outside of a vessel. In such an example, a fluid level in the vessel is adjusted to a first fluid level. Sensing of a user's touch input may be performed via a touch sensor plate of the fluid level sensor. The fluid level sensor may be driven from an operation mode into a configuration mode in response to sensing the user's touch input. The fluid level sensor may be reprogrammed to accept a first fluid level condition in response to sensing the user's touch input and in response to sensing the first fluid level.

In another example, a fluid level sensor includes a housing, a fluid level sensor plate, a touch device, and a control unit. The fluid level sensor plate comprises a plate of conductive material. The fluid level sensor plate and the touch device are located within the housing. The control unit is coupled to the fluid level sensor plate and the touch device. The control unit is configured to determine fluid presence based on fluid level data from the fluid level sensor plate and determine touch input based on touch data from the touch device.

This Summary is provided to introduce a selection of concepts in a simplified form that are further described below in the Detailed Description. The foregoing Summary, as well as the following Detailed Description of certain implementations, will be better understood when read in conjunction with the appended drawings. This Summary is not intended to identify key features or essential features of the claimed subject matter, nor is it intended to be used as an aid in determining the scope of the claimed subject matter.

### BRIEF DESCRIPTION OF THE DRAWINGS

The foregoing and other features and advantages will be discussed in detail in the following non-limiting description of specific embodiments in connection with the accompanying drawings, in which:

FIG. 1 illustrates a schematic view of a fluid level sensor according to an example of the instant disclosure;

FIG. 2 illustrates a cross sectional side view of a fluid level sensor according to an example of the instant disclosure;

FIG. 3 is an illustration of a flowchart of an example method for fluid level sensor reprograming according to an example of the instant disclosure;

FIG. 4 is an illustration of a flowchart of another example method for fluid level sensor reprograming according to an example of the instant disclosure;

FIG. 5 is an illustration of a flowchart of a further example method for fluid level sensor reprograming according to an example of the instant disclosure;

FIG. 6 is an illustration of a flowchart of a still further example method for fluid level sensor reprograming according to an example of the instant disclosure;

FIG. 7 is a block diagram illustrating a computer program product according to an example of the instant disclosure;

FIG. 8 is a block diagram illustrating an example fluid delivery apparatus according to an example of the instant disclosure; and

FIG. 9 is a block diagram illustrating a hardware apparatus including a semiconductor package according to an example of the instant disclosure.

### DETAILED DESCRIPTION OF THE PRESENT EMBODIMENTS

As will be described in greater detail below, in some implementations discussed herein, rather than powering a teach wire in a specific sequence to force the fluid level sensor into a configuration mode, a user may place their finger or other suitable conductive surface on a touch sensor plate or other touch device in a pre-determined sequence (for example, a certain number of touches within a certain time period) to drive the fluid level sensor into a configuration mode. From there the user would create the “dry” sensor condition physically and then “teach” the fluid level sensor by placing their finger back on the touch sensor plate or other touch device for a predetermined time (or some other pre-determined sequence) for the fluid level sensor to accept the new condition. Then the user would put the fluid level sensor in the “wet” condition physically and “teach” the fluid level sensor by placing their finger back on the touch sensor plate or other touch device for a predetermined time (or some other pre-determined sequence) for the fluid level sensor to accept the new condition. Finally, the user would wait for an indication (such as a specific pattern of blinking LED) as confirmation from the fluid level sensor that the new configuration has been successfully accepted by the fluid level sensor. This process can be repeated as many times as desired.

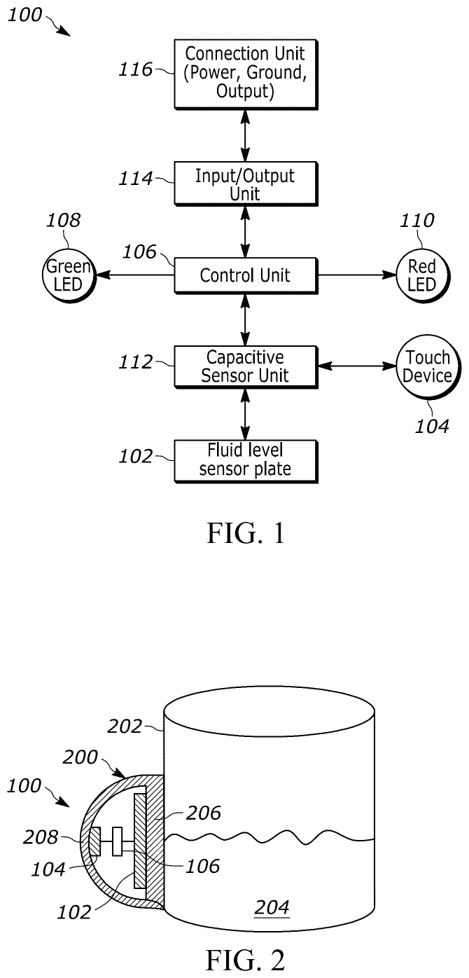

FIG. 1 illustrates a schematic view of a fluid level sensor 100 according to an example of the instant disclosure. As will be discussed in greater detail below, the fluid level sensor 100 includes a fluid level sensor plate 102, a touch device 104, and a control unit 106.

The fluid level sensor plate 102 comprises a plate of conductive material (e.g., copper or the like) paired with a corresponding reference electrode. The fluid level sensor plate 102 monitor an electric field generated by the plate of conductive material and the corresponding reference electrode. In some implementations the fluid level sensor plate 102 is a continuous sensor plate to measure various levels of fluid. Alternatively, in other implementations, the fluid level sensor plate 102 is a point sensor plate to measure the presence and absence of fluid.

The touch device 104 may be implemented as a touch sensor plate comprising a plate of conductive material (e.g., copper or the like) paired with a corresponding reference electrode. The touch device 104 monitor an electric field generated by the plate of conductive material and the corresponding reference electrode. Alternatively, the touch device 104 may be implemented as a push button, inserting and removing a conductive rod into a blind pocket, or any other form.

For example, the push button implementation would utilize a momentary normally open switch and a pullup resistor that would connect to one of the IO pins of the control unit 106. Accordingly, instead of using a finger to activate the plate of conductive material, a user's touch would close the open switch to activate the touch device 104.

In another example, the conductive rod implementation would work similarly as a touch sensor plate comprising a plate of conductive material. However, instead of using a finger to activate the plate of conductive material, a conductive rod in a blind pocket would be used to activate the plate of conductive material in response to a user pressing on the conductive rod. The blind pocket comprises a hole holding the conductive rod. The hole is formed in the housing (e.g., see housing 200 described below with respect to FIG. 2) of the fluid level sensor 100, where the hole doesn't go all way through the fluid level sensor 100 or, in other words, a closed-end hole. In this case, the conductive rod is inserted into the blind pocket where the conductive rod would not come in direct contact with any conductive terminals such as the plate of conductive material. The conductive rod coming in close proximity of the plate of conductive material would cause a change in capacitance and would be detected as a switch closure.

The control unit 106 is coupled to the fluid level sensor plate 102 and the touch device 104. For example, the control unit 106 may be coupled to the fluid level sensor plate 102 and the touch device 104 via a capacitive sensor unit 112. The control unit 106 is configured to determine fluid presence based on fluid level data from the fluid level sensor plate 102 and determine touch input based on touch data from the touch device 104.

The capacitive sensor unit 112 converts output from the fluid level sensor plate 102 into fluid level data and convert output from the touch device 104 into touch data for use by the control unit 106. For example, the capacitive sensor unit 112 may be a commercially available capacitive sensor (e.g., part number FDC1004 from Texas Instruments™).

An input/output unit 114 is coupled to the control unit 106. The input/output unit 114 includes a linear regulator to maintain a stable output voltage for the fluid level sensor 100.

A connection unit 116 is coupled to the input/output unit 114. The connection unit 116 is to provide a power connection, a ground connection, and a data output connection for the fluid level sensor 100.

The control unit 106 is further coupled to a light emitting device. As illustrated, the control unit 106 is coupled to a first light emitting diode (LED) 110 (illustrated here as a red LED, although another color may be utilized and/or another type of a light emitting device may be utilized) to communicate that the fluid level sensor 100 is powered up and to communicate reprograming conditions of the fluid level sensor 100 and a second LED 108 (illustrated here as a green LED, although another color may be utilized and/or another type of a light emitting device may be utilized) to indicate when the fluid level sensor 100 output is active.

In operation the fluid level sensor 100 is positioned on the outside of a vessel. In such an example, a fluid level in the vessel is adjusted to a first fluid level (e.g., a dry fluid level in implementation where the fluid level sensor plate 102 is a point sensor plate or a low fluid level in implementations where the fluid level sensor plate 102 is a continuous sensor plate). Sensing of a user's touch input may be performed via the touch device 104 of the fluid level sensor 100. The fluid level sensor 100 may be driven from an operation mode into a configuration mode in response to sensing the user's touch input via the touch device 104. The fluid level sensor 100 may be reprogrammed to accept a first fluid level condition (e.g., a dry condition in implementation where the fluid level sensor plate 102 is a point sensor plate or a low level condition in implementations where the fluid level sensor plate 102 is a continuous sensor plate) in response to sensing the user's touch input and in response to sensing the first fluid level. Subsequently, the fluid level in the vessel may be adjusted to a second fluid level (e.g., a wet fluid level in implementation where the fluid level sensor plate 102 is a point sensor plate or a high fluid level in implementations where the fluid level sensor plate 102 is a continuous sensor plate). The fluid level sensor 100 may then be reprogrammed to accept a second fluid level condition (e.g., a wet condition in implementation where the fluid level sensor plate 102 is a point sensor plate or a high level condition in implementations where the fluid level sensor plate 102 is a continuous sensor plate) in response to sensing the user's touch input via the touch device 104 and in response to sensing the second fluid level. A visual indication of completed reprogramming may be output via the LED 110 after reprogramming acceptance of the first fluid level condition and the second fluid level condition.

FIG. 2 illustrates a cross sectional side view of the fluid level sensor 100 according to an example of the instant disclosure. As will be discussed in greater detail below, the fluid level sensor 100 may be affixed to a vessel 202 containing liquid 204.

The fluid level sensor 100 includes a housing 200 having a vessel side wall 206 and an outer side wall 208 positioned opposite the vessel side wall 206. As illustrated, the outer side wall 208 may have a domed shape, although other shapes may be utilized. As illustrated, the vessel side wall 206 may have a flat shape or a curved shape adapted to the shape of the vessel 202, although other shapes may be utilized.

The fluid level sensor plate 102 is located within the housing 200 and coupled to the vessel side wall 206. Similarly, the touch device 104 is located within the housing 200 and coupled to the outer wall 208.

In some implementations, the housing 200 is sealed from water and dust intrusion. In some examples, the housing 200 is at least one of transparent or translucent. Accordingly, the light emitting devices 108 and/or 110 (illustrated in FIG. 1) located within the housing 200 may light up the housing 200.

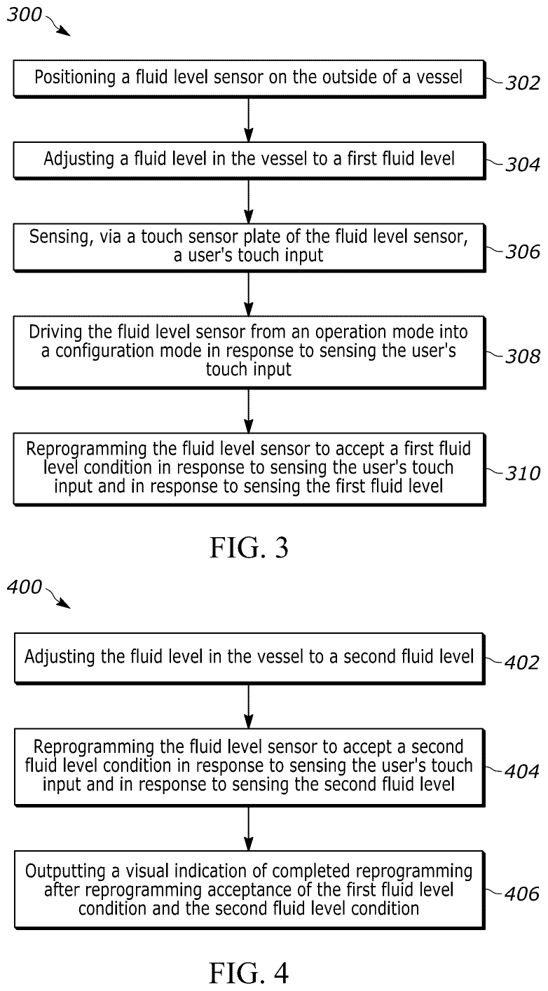

FIG. 3 is a flowchart of an example of a method 300 for fluid level sensor reprograming according to an example. The method 300 may generally be implemented in an apparatus, such as, for example, the fluid level sensor 100 (FIG. 1) and/or the fluid level sensor 100 (FIG. 2), already discussed.

Illustrated processing block 302 provides for positioning a fluid level sensor. For example, a fluid level sensor may be positioned on the outside of a vessel.

Illustrated processing block 304 provides for adjusting a fluid level in the vessel. For example, a fluid level in the vessel may be adjusted to a first fluid level.

In some implementations, the first fluid level condition is a dry condition or a wet condition in implementations where the fluid level sensor plate is a point sensor plate to measure the presence and absence of fluid. Alternatively, the first fluid level condition is a low level fluid condition or a high level fluid condition in implementations where the fluid level sensor plate is a continuous sensor plate adapted to measure various levels of fluid.

Illustrated processing block 306 provides for sensing a user's touch input. For example, a user's touch input may be sensed via a touch sensor plate of the fluid level sensor.

Illustrated processing block 308 provides for driving the fluid level sensor from an operation mode into a configuration mode. For example, the fluid level sensor may be driven from an operation mode into a configuration mode in response to sensing the user's touch input.

Illustrated processing block 310 provides for reprogramming the fluid level sensor. For example, the fluid level sensor may be reprogramed to accept a first fluid level condition in response to sensing the user's touch input and in response to sensing the first fluid level.

Additional, or alternative details of method 300 are described below with respect to FIGS. 4-6.

FIG. 4 is a flowchart of another example of a method 400 for fluid level sensor reprograming according to an example. The method 600 may generally be implemented in an apparatus, such as, for example, the fluid level sensor 100 (FIG. 1) and/or the fluid level sensor 100 (FIG. 2), already discussed.

Illustrated processing block 402 provides for adjusting the fluid level in the vessel. For example, the fluid level in the vessel may be adjusted to a second fluid level.

In some implementations, the first fluid level condition is a dry condition and the second fluid level condition is a wet condition (or vice versa) in implementations where the fluid level sensor plate is a point sensor plate to measure the presence and absence of fluid. Alternatively, the first fluid level condition is a low level fluid condition and the second fluid level condition is a high level fluid condition (or vice versa) in implementations where the fluid level sensor plate is a continuous sensor plate adapted to measure various levels of fluid.

Illustrated processing block 404 provides for reprogramming the fluid level sensor. For example, the fluid level sensor may be reprogrammed to accept a second fluid level condition in response to sensing the user's touch input and in response to sensing the second fluid level.

Illustrated processing block 406 provides for outputting a visual indication of completed reprogramming. For example, a visual indication of completed reprogramming may be output after reprogramming acceptance of the first fluid level condition and the second fluid level condition.

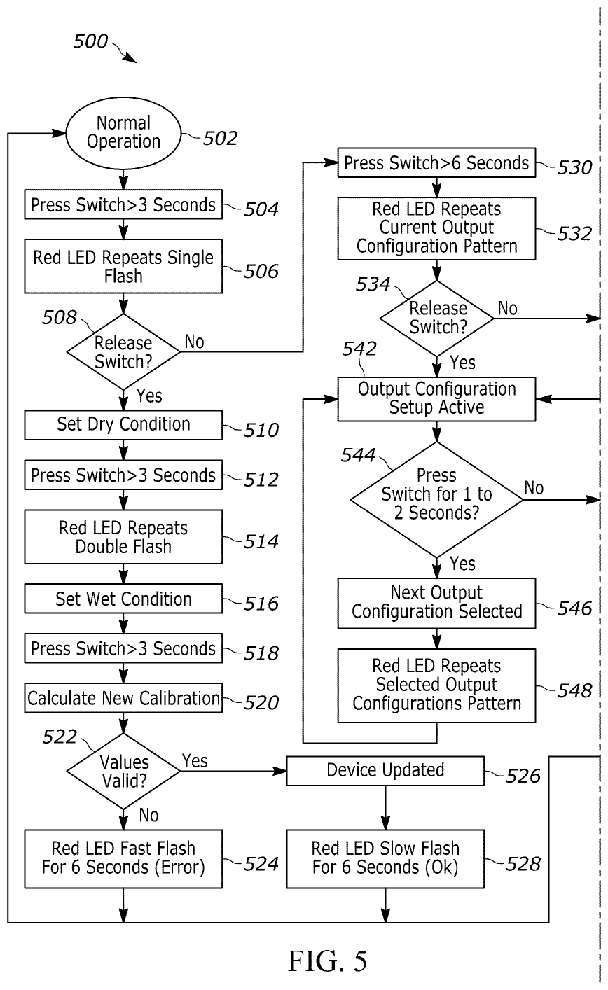

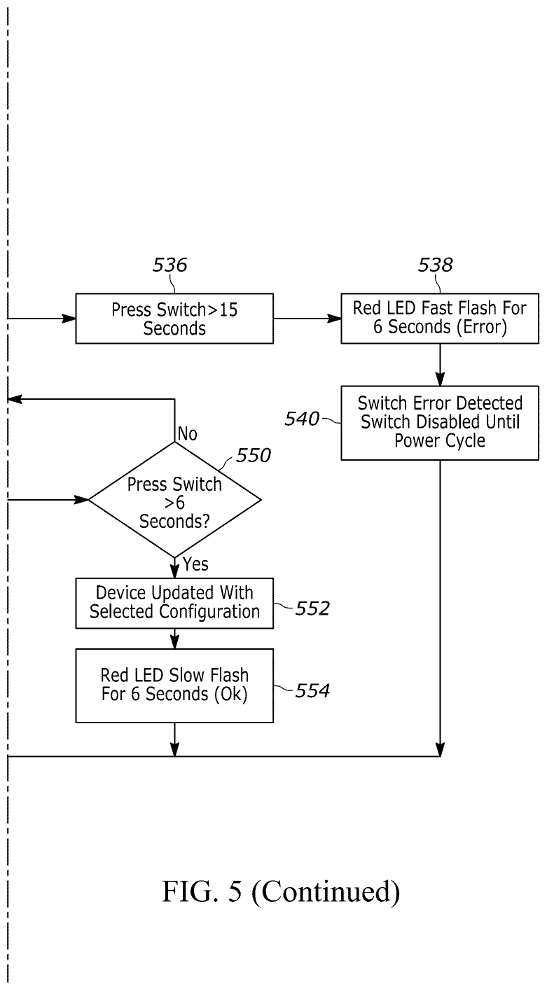

FIG. 5 is a flowchart of another example of a method 500 for fluid level sensor reprograming according to an example. The method 500 may generally be implemented in an apparatus, such as, for example, the fluid level sensor 100 (FIG. 1) and/or the fluid level sensor 100 (FIG. 2), already discussed.

In an example, the method 500 (as well as method 600) can be implemented in computer readable instructions (e.g., software), configurable computer readable instructions (e.g., firmware), fixed-functionality computer readable instructions (e.g., hardware), etc., or any combination thereof.

It will be appreciated that some or all of the operations the method 500 (as well as method 600) are described using a “pull” architecture (e.g., polling for new information followed by a corresponding response) can instead be implemented using a “push” architecture (e.g., sending such information when there is new information to report), and vice versa.

Illustrated processing block 502-554 illustrate programing dry and wet conditions for implementations where the fluid level sensor plate is a point sensor plate to measure the presence and absence of fluid. The periods of time utilized in the various operations are merely examples and other periods of time may be utilized. Likewise, the various flashing patterns in the various operations are merely examples and other flashing patterns may be utilized.

Illustrated processing block 502 provides for normal operation conditions. At block 504, a determination is made that a switch (e.g., a touch device) has been pressed for a period of time (e.g., greater than three seconds). At block 506, the red LED (in some implementations a different color LED may be utilized) repeats a signal (e.g., a single flash) indicating that a dry condition is to be set.

At block 508, a determination is made as to whether the switch has been released. At block 510, in situations where the switch has been released a dry condition will be set. At block 512, a determination is made that the switch has been pressed for a period of time (e.g., greater than three seconds). At block 514, the red LED repeats a signal (e.g., a double flash) indicating that a wet condition is to be set. At block 516, a wet condition will be set.

At block 518, a determination is made that the switch has been pressed for a period of time (e.g., greater than three seconds). At block 520, a new calibration will be calculated based on the newly set dry condition and wet condition (e.g., setting thresholds for what is considered wet and dry conditions).

At block 522, a determination is made as to whether the values from the new calibration are valid (e.g., whether the values make sense). For example, a determination is made as to whether there is enough dynamic range between dry and wet condition (e.g., over a threshold value), and an error would occur if the dry and wet values are too close in value to each other. If not, at block 524, the red LED repeats a signal (e.g., a fast flash for six seconds) indicating that the values are not valid and the system returns to normal operation. If the values are valid, at block 526, the device (e.g., the fluid level sensor) is updated with the new calibration. At block 528, the red LED repeats a signal (e.g., a slow flash for six seconds) indicating that the device is updated with the new calibration and the system returns to normal operation.

At block 530, in situations where the switch has not been released at block 508, method 500 proceeds to block 530 where a determination is made that the switch has been pressed for greater than six seconds. In response, at block 532, the red LED repeats a signal indicating the current output configuration pattern. For example, one slow and one fast flash may indicate an active wet sinking output configuration (e.g., when the device sees fluid is present then the device provides a ground path for the load), one slow and two fast flashes may indicate an active dry sinking output configuration (e.g., when the device sees fluid is absent then the device provides a ground path for the load), one slow and three fast flashes may indicate an active wet sourcing output configuration (e.g., when the device sees fluid is present then the device sources power to the load), and one slow and four fast flashes may indicate an active dry sourcing output configuration (e.g., when the device sees fluid is absent then the device sources power to the load). For example, “sinking” in the industry means to provide the low side or ground of the load while “sourcing” means to provide the power to the load, so sinking provides ground and sourcing provides power.

At block 534, a determination is made as to whether the switch has been released or not. In situations where the switch has not been released at block 534, method 500 proceeds to block 536 where a determination is made that the switch has been pressed for greater than fifteen seconds. When this occurs, at block 538 the red LED repeats a signal (e.g., a fast flash for six seconds) indicating and error. At block 540, a determination is made that a switch error has been detected and the switch will be disabled until the next power cycle and the system returns to normal operation.

In situations where the switch has been released at block 534, method 500 proceeds to block 542 where a determination is made that the output configuration is active. At block 544, a determination is made as to whether the switch has been pressed for one to two seconds. In situations where the switch has been pressed for one to two seconds at block 544, method 500 proceeds to block 546 where the next output configuration is selected (e.g., alternating between an active wet sinking output configuration, an active dry sinking output configuration, an active wet sourcing output configuration, and an active dry sourcing output configuration, as described above). At block 548 the red LED repeats a signal indicating the selected output configuration pattern (e.g., one slow and one fast flash, one slow and two fast flashes, one slow and three fast flashes, or one slow and four fast flashes).

In situations where the switch has not been pressed for one to two seconds at block 544, method 500 proceeds to block 550 where a determination is made as to whether the switch has been pressed for more than six seconds. If so, method 500 proceeds to block 552 where the device is updated with the selected configuration (e.g., an active wet sinking output configuration, an active dry sinking output configuration, an active wet sourcing output configuration, or an active dry sourcing output configuration). At block 528, the red LED repeats a signal (e.g., a slow flash for six seconds) indicating that the device is updated with the new selected configuration and the system returns to normal operation.

Additionally, during the operation of method 500, the green LED (in some implementations a different color LED may be utilized) will flash whenever the switch is in an active operating condition.

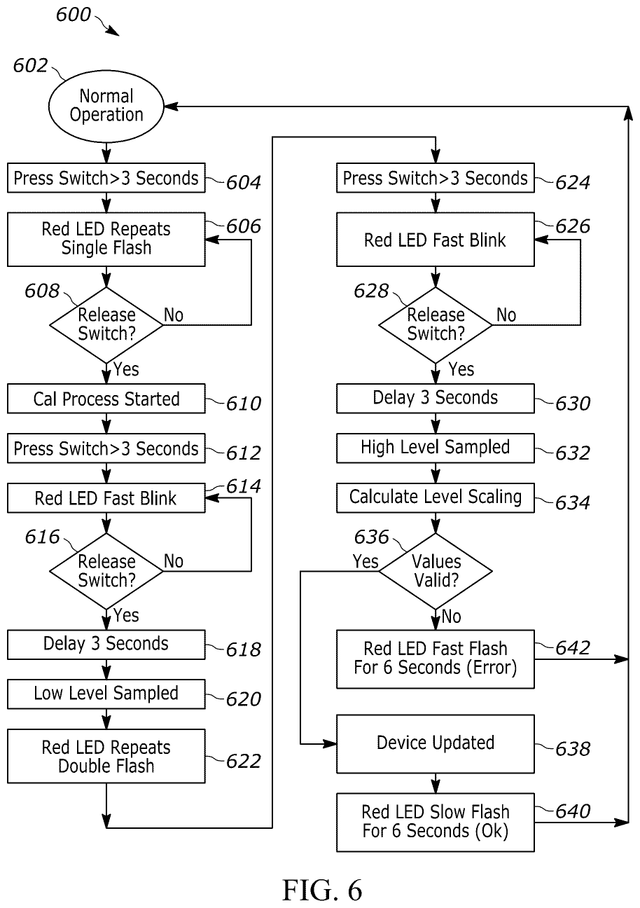

FIG. 6 is a flowchart of another example of a method 600 for fluid level sensor reprograming according to an example. The method 600 may generally be implemented in an apparatus, such as, for example, the fluid level sensor 100 (FIG. 1) and/or the fluid level sensor 100 (FIG. 2), already discussed.

Illustrated processing block 602-642 illustrate programing dry and wet conditions for implementations where the fluid level sensor plate is a continuous sensor plate to measure various levels of fluid. The periods of time utilized in the various operations are merely examples and other periods of time may be utilized. Likewise, the various flashing patterns in the various operations are merely examples and other flashing patterns may be utilized.

Illustrated processing block 602 provides for normal operation conditions. At block 604, a determination is made that a switch (e.g., a touch device) has been pressed for a period of time (e.g., greater than three seconds). At block 606, the red LED (in some implementations a different color LED may be utilized) repeats a signal (e.g., a single flash) indicating that a calibration process is to be started.

At block 608, a determination is made as to whether the switch has been released. If not, method 600 proceeds back to block 606. If so, method 600 proceeds to block 610 where a determination is made to proceed with starting the calibration process.

At block 612, a determination is made that a switch (e.g., a touch device) has been pressed for a period of time (e.g., greater than three seconds). At block 614, the red LED repeats a signal (e.g., a fast blink) indicating that a low level fluid condition is to be set.

At block 616, a determination is made as to whether the switch has been released. If not, method 600 proceeds back to block 614. If so, method 600 proceeds to block 618 where there is a delay for three seconds. At block 620 the low level fluid condition is sampled. At block 622, the red LED repeats a signal (e.g., a double flash) indicating that a low level fluid condition has been set.

At block 624, a determination is made that a switch (e.g., a touch device) has been pressed for a period of time (e.g., greater than three seconds). At block 626, the red LED repeats a signal (e.g., a fast blink) indicating that a high level fluid condition is to be set.

At block 628, a determination is made as to whether the switch has been released. If not, method 600 proceeds back to block 626. If so, method 600 proceeds to block 630 where there is a delay for three seconds. At block 632 the high level fluid condition is sampled. At block 634 a level scaling will be calculated based on the set low level fluid condition (e.g., set as zero percent of full) and the set high level fluid condition (e.g., set as one hundred percent of full).

At block 636, a determination is made as to whether the values from the calculated level scaling are valid (e.g., whether the values make sense). For example, a determination is made as to whether there is enough dynamic range between low level fluid and high level fluid conditions (e.g., over a threshold value), and an error would occur if the low level fluid and high level fluid values are too close in value to each other. If so, at block 640, the fluid level sensor is updated. At block 640, the red LED repeats a signal (e.g., a slow flash for six seconds) indicating that fluid level sensor has been updated and the system returns to normal operation. If not, at block 642, the red LED repeats a signal (e.g., a fast flash for six seconds) indicating that there has been some error and the system returns to normal operation.

Additionally, during the operation of method 600, the green LED (in some implementations a different color LED may be utilized) will flash whenever the switch is active.

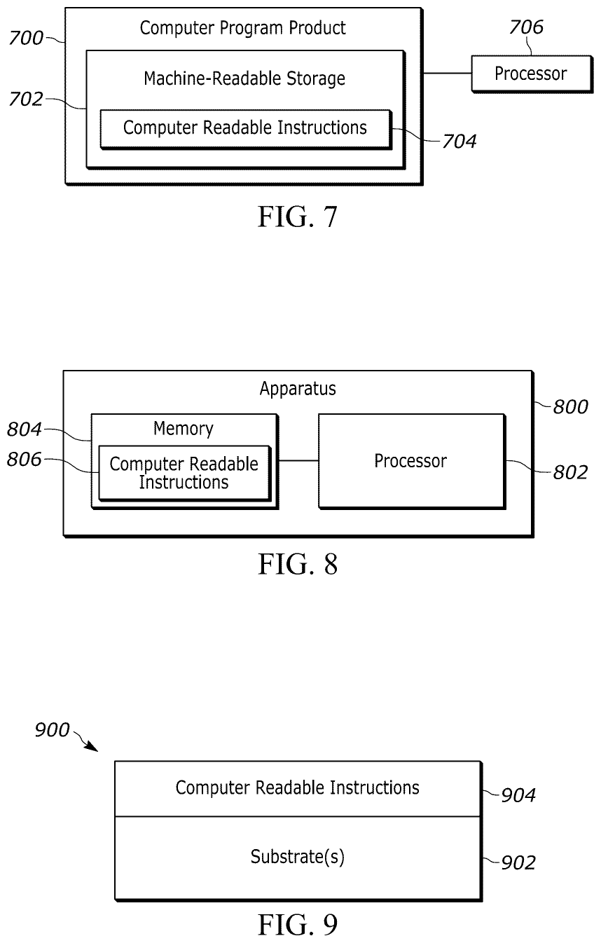

FIG. 7 illustrates a block diagram of an example computer program product 700. In some examples, as shown in FIG. 7, computer program product 700 includes a machine-readable storage 702 that can also include computer readable instructions 704. In some implementations, the machine-readable storage 702 can be implemented as a non-transitory machine-readable storage. In some implementations the computer readable instructions 704, which can be implemented as software, for example. In an example, the computer readable instructions 704, when executed by a processor 706, implement one or more aspects of the method 300 (FIG. 3), method 400 (FIG. 4), method 500 (FIG. 5) and/or method 600 (FIG. 6), already discussed.

FIG. 8 shows an illustrative example of an apparatus 800. In the illustrated example, the apparatus 800 can include a processor 802 and a memory 804 communicatively coupled to the processor 802. The memory 804 can include computer readable instructions 806, which can be implemented as software, for example. In an example, the computer readable instructions 806, when executed by the processor 802, implement one or more aspects of the method 300 (FIG. 3), method 400 (FIG. 4), method 500 (FIG. 5) and/or method 600 (FIG. 6), already discussed.

In some implementations, the processor 802 can include a general purpose controller, a special purpose controller, a storage controller, a storage manager, a memory controller, a micro-controller, a general purpose processor, a special purpose processor, a central processor unit (CPU), the like, and/or combinations thereof.

Further, implementations can include distributed processing, component/object distributed processing, parallel processing, the like, and/or combinations thereof. For example, virtual computer system processing can implement one or more of the methods or functionalities as described herein, and the processor 802 described herein can be used to support such virtual processing.

In some examples, the memory 804 is an example of a computer-readable storage medium. For example, memory 804 can be any memory which is accessible to the processor 802, including, but not limited to RAM memory, registers, and register files, the like, and/or combinations thereof. References to “computer memory” or “memory” should be interpreted as possibly being multiple memories. The memory can for instance be multiple memories within the same computer system. The memory can also be multiple memories distributed amongst multiple computer systems or computing devices.

FIG. 9 shows an illustrative semiconductor apparatus 900 (e.g., chip and/or package). The illustrated apparatus 900 includes one or more substrates 902 (e.g., silicon, sapphire, or gallium arsenide) and computer readable instructions 904 (such as, configurable computer readable instructions (e.g., firmware) and/or fixed-functionality computer readable instructions (e.g., hardware)) coupled to the substrate(s) 902. In an example, the computer readable instructions 904 implement one or more aspects of the method 300 (FIG. 3), method 400 (FIG. 4), method 500 (FIG. 5) and/or method 600 (FIG. 6), already discussed.

In some implementations, computer readable instructions 904 can include transistor array and/or other integrated circuit (IC) components. For example, configurable firmware logic and/or fixed-functionality hardware logic implementations of the computer readable instructions 904 can include configurable computer readable instructions such as, for example, programmable logic arrays (PLAs), field programmable gate arrays (FPGAs), complex programmable logic devices (CPLDs), or fixed-functionality computer readable instructions (e.g., hardware) using circuit technology such as, for example, application specific integrated circuit (ASIC), complementary metal oxide semiconductor (CMOS) or transistor-transistor logic (TTL) technology, the like, and/or combinations thereof.

### Additional Notes and Examples

Clause 1 is a fluid level sensor, comprising: a fluid level sensor plate comprising a plate of conductive material; a touch sensor plate comprising a plate of conductive material; and a control unit coupled to the fluid level sensor plate and the touch sensor plate, the control unit configured to: determine fluid presence based on fluid level data from the fluid level sensor plate; and determine touch input based on touch data from the touch sensor plate.
Clause 2 includes the fluid level sensor of clause 1, further comprising: a housing having a vessel side wall and an outer side wall positioned opposite the vessel side wall; wherein the fluid level sensor plate is located within the housing and coupled to the vessel side wall; and wherein the touch sensor plate is located within the housing and coupled to the outer wall.
Clause 3 includes the fluid level sensor of clause 2, wherein the housing is sealed from water and dust intrusion.
Clause 4 includes the fluid level sensor of any one of Clauses 2 to 3, wherein the housing is at least one of transparent or translucent.
Clause 5 includes the fluid level sensor of any one of Clauses 2 to 4, further comprising a light emitting device output coupled to the control unit to light up the housing.
Clause 6 includes the fluid level sensor of clause 5, wherein the light emitting device comprises a first light emitting diode (LED) to communicate that the fluid level sensor is powered up and to communicate reprograming conditions of the fluid level sensor and a second LED to indicate when the fluid level sensor output is active.
Clause 7 includes the fluid level sensor of any one of Clauses 1 to 6, wherein the fluid level sensor, further comprises: a capacitive sensor unit to convert output from the fluid level sensor plate into fluid level data and convert output from the touch sensor plate into touch data, wherein the control unit is coupled to the fluid level sensor plate and the touch sensor plate via the capacitive sensor unit; an input/output unit coupled to the control unit, the input/output unit including a linear regulator to maintain a stable output voltage for the fluid level sensor; and a connection unit coupled to the input/output unit, the connection unit to provide a power connection, a ground connection, and a data output connection for the fluid level sensor.
Clause 8 includes the fluid level sensor of any one of Clauses 1 to 7, wherein the fluid level sensor plate is a continuous sensor plate to measure various levels of fluid.
Clause 9 includes the fluid level sensor of any one of Clauses 1 to 7, wherein the fluid level sensor plate is a point sensor plate to measure the presence and absence of fluid.
Clause 10 includes the fluid level sensor of any one of Clauses 1 to 9, wherein the fluid level sensor plate and the touch sensor plate are composed of copper.
Clause 11 is a method comprising: positioning a fluid level sensor on the outside of a vessel; adjusting a fluid level in the vessel to a first fluid level; sensing, via a touch sensor plate of the fluid level sensor, a user's touch input; driving the fluid level sensor from an operation mode into a configuration mode in response to sensing the user's touch input; and reprogramming the fluid level sensor to accept a first fluid level condition in response to sensing the user's touch input and in response to sensing the first fluid level.
Clause 12 includes the method of clause 11, further comprising: adjusting the fluid level in the vessel to a second fluid level; and reprogramming the fluid level sensor to accept a second fluid level condition in response to sensing the user's touch input and in response to sensing the second fluid level.
Clause 13 includes the method of clause 12, wherein the first fluid level condition is a dry condition and the second fluid level condition is a wet condition.
Clause 14 includes the method of clause 12, wherein the first fluid level condition is a low level fluid condition and the second fluid level condition is a high level fluid condition.
Clause 15 includes the method of any one of Clauses 11 to 14, further comprising: outputting a visual indication of completed reprogramming after reprogramming acceptance of the first fluid level condition and the second fluid level condition.
Clause 16 is a fluid level sensor, comprising: a housing sealed from water and dust intrusion; a fluid level sensor plate comprising a plate of conductive material, wherein the fluid level sensor plate is located within the housing; a touch device located within the housing; and a control unit coupled to the fluid level sensor plate and the touch device, the control unit to: determine fluid presence based on fluid level data from the fluid level sensor plate; and determine touch input based on touch data from the touch device.
Clause 17 includes the fluid level sensor of clause 16, wherein the housing is at least one of transparent or translucent.
Clause 18 includes the fluid level sensor of clause 17, further comprising a light emitting device output coupled to the control unit to light up the housing, wherein the light emitting device comprises a first light emitting diode (LED) to communicate that the fluid level sensor is powered up and to communicate reprograming conditions of the fluid level sensor and a second LED to indicate when the fluid level sensor output is active.
Clause 19 includes the fluid level sensor of any one of Clauses 16 to 18, wherein the fluid level sensor plate is a continuous sensor plate to measure various levels of fluid.
Clause 20 includes the fluid level sensor of any one of Clauses 16 to 18, wherein the fluid level sensor plate is a point sensor plate to measure the presence and absence of fluid.
Clause 21 includes a machine-readable storage including machine-readable instructions, which when executed, implement a method or realize an apparatus as claimed in any preceding Clause.
Clause 22 includes an apparatus including means for performing the function of any preceding Clause.

All definitions, as defined and used herein, should be understood to control over dictionary definitions, definitions in documents incorporated by reference, and/or ordinary meanings of the defined terms.

Furthermore, for ease of understanding, certain functional blocks can have been delineated as separate blocks; however, these separately delineated blocks should not necessarily be construed as being in the order in which they are discussed or otherwise presented herein. For example, some blocks can be able to be performed in an alternative ordering, simultaneously, etc.

As used herein, phrases substantially similar to “at least one of A, B or C” are intended to be interpreted in the disjunctive, i.e., to require A or B or C or any combination thereof unless stated or implied by context otherwise. Further, phrases substantially similar to “at least one of A, B and C” are intended to be interpreted in the conjunctive, i.e., to require at least one of A, at least one of B and at least one of C unless stated or implied by context otherwise. Further still, the term “substantially” or similar words requiring subjective comparison are intended to mean “within manufacturing tolerances”unless stated or implied by context otherwise.

As used herein, the terms “coupled,” “attached,” “connected,” or “operatively connected” can be used herein to refer to any type of relationship, direct or indirect, between the components in question. For example, the terms “coupled,” “attached,” “connected,” or “operatively connected” may refer to at least a functional relationship between two elements and may encompass configurations in which the two elements are directed connected to each other, i.e., without any intervening elements, or indirectly connected to each other, i.e., with intervening elements. Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action can occur, either in a direct or indirect manner.

Although a number of illustrative examples are described herein, it should be understood that numerous other modifications and examples can be devised by those skilled in the art that will fall within the spirit and scope of the principles of the foregoing disclosure. More particularly, reasonable variations and modifications are possible in the component parts and/or arrangements of the subject combination arrangement within the scope of the foregoing disclosure, the drawings and the appended claims without departing from the spirit of the foregoing disclosure. In addition to variations and modifications in the component parts and/or arrangements, alternative uses will also be apparent to those skilled in the art. The examples can be combined to form additional examples.

What is claimed is:

1. A fluid level sensor, comprising:
a fluid level sensor plate comprising a plate of conductive material;
a touch sensor plate comprising a plate of conductive material; and
a control unit coupled to the fluid level sensor plate and the touch sensor plate, the control unit configured to:
determine fluid presence based on fluid level data from the fluid level sensor plate; and
determine touch input based on touch data from the touch sensor plate.

2. The fluid level sensor of claim 1, further comprising:
a housing having a vessel side wall and an outer side wall positioned opposite the vessel side wall;
wherein the fluid level sensor plate is located within the housing and coupled to the vessel side wall; and
wherein the touch sensor plate is located within the housing and coupled to the outer wall.

3. The fluid level sensor of claim 2, wherein the housing is sealed from water and dust intrusion.

4. The fluid level sensor of claim 2, wherein the housing is at least one of transparent or translucent.

5. The fluid level sensor of claim 2, further comprising a light emitting device output coupled to the control unit to light up the housing.

6. The fluid level sensor of claim 5, wherein the light emitting device comprises a first light emitting diode (LED) to communicate that the fluid level sensor is powered up and to communicate reprograming conditions of the fluid level sensor and a second LED to indicate when the fluid level sensor output is active.

7. The fluid level sensor of claim 1, wherein the fluid level sensor further comprises:
a capacitive sensor unit to convert output from the fluid level sensor plate into fluid level data and convert output from the touch sensor plate into touch data, wherein the control unit is coupled to the fluid level sensor plate and the touch sensor plate via the capacitive sensor unit;
an input/output unit coupled to the control unit, the input/output unit including a linear regulator to maintain a stable output voltage for the fluid level sensor; and
a connection unit coupled to the input/output unit, the connection unit to provide a power connection, a ground connection, and a data output connection for the fluid level sensor.

8. The fluid level sensor of claim 1, wherein the fluid level sensor plate is a continuous sensor plate to measure various levels of fluid.

9. The fluid level sensor of claim 1, wherein the fluid level sensor plate is a point sensor plate to measure the presence and absence of fluid.

10. The fluid level sensor of claim 1, wherein the fluid level sensor plate and the touch sensor plate are composed of copper.

11. A method comprising:
positioning a fluid level sensor on the outside of a vessel;
adjusting a fluid level in the vessel to a first fluid level;
sensing, via a touch sensor plate of the fluid level sensor, a user's touch input;
driving the fluid level sensor from an operation mode into a configuration mode in response to sensing the user's touch input; and
reprogramming the fluid level sensor to accept a first fluid level condition in response to sensing the user's touch input and in response to sensing the first fluid level.

12. The method of claim 11, further comprising:
adjusting the fluid level in the vessel to a second fluid level; and
reprogramming the fluid level sensor to accept a second fluid level condition in response to sensing the user's touch input and in response to sensing the second fluid level.

13. The method of claim 12, wherein the first fluid level condition is a dry condition and the second fluid level condition is a wet condition.

14. The method of claim 12, wherein the first fluid level condition is a low level fluid condition and the second fluid level condition is a high level fluid condition.

15. The method of claim 11, further comprising:
outputting a visual indication of completed reprogramming after reprogramming acceptance of the first fluid level condition and the second fluid level condition.

16. A fluid level sensor, comprising:
a housing sealed from water and dust intrusion;
a fluid level sensor plate comprising a plate of conductive material, wherein the fluid level sensor plate is located within the housing;
a touch device located within the housing; and
a control unit coupled to the fluid level sensor plate and the touch device, the control unit to:
determine fluid presence based on fluid level data from the fluid level sensor plate; and
determine touch input based on touch data from the touch device.

17. The fluid level sensor of claim 16, wherein the housing is at least one of transparent or translucent.

18. The fluid level sensor of claim 17, further comprising a light emitting device output coupled to the control unit to light up the housing, wherein the light emitting device comprises a first light emitting diode (LED) to communicate that the fluid level sensor is powered up and to communicate reprograming conditions of the fluid level sensor and a second LED to indicate when the fluid level sensor output is active.

19. The fluid level sensor of claim 16, wherein the fluid level sensor plate is a continuous sensor plate to measure various levels of fluid.

20. The fluid level sensor of claim 16, wherein the fluid level sensor plate is a point sensor plate to measure the presence and absence of fluid.
